(19) United States
(12) Patent Application Publication
(10) Pub. No.: US 2023/0319602 A1
(43) Pub. Date: Oct. 5, 2023

(54) SYSTEMS AND METHODS FOR DYNAMIC EDGE DISCOVERY AFTER A PROTOCOL DATA UNIT SESSION ANCHOR FAILOVER

(71) Applicant: Verizon Patent and Licensing Inc., Basking Ridge, NJ (US)

(72) Inventors: Syed REHMAN, South Brunswick, NJ (US); Raghuram PARVATANENI, Plano, TX (US); Ankita KOHLI, Hyderabad (IN); John Patrick HICKEY, III, Metuchen, NJ (US)

(73) Assignee: Verizon Patent and Licensing Inc., Basking Ridge, NJ (US)

(21) Appl. No.: 17/657,425

(22) Filed: Mar. 31, 2022

(51) Int. Cl. H04W 24/04; H04W 76/19

(52) U.S. Cl. CPC H04W 24/04; H04W 76/19; H04W 80/10

(57) ABSTRACT

A device may receive a protocol data unit session anchor (PSA) failure alarm associated with a first PSA at a first site with a first edge device, and may receive a PSA active alarm associated with a second PSA at a second site. The device may receive latency data identifying a latency between the first site and the second site, and may determine a failover from the first PSA to the second PSA based on the PSA failure alarm and the PSA active alarm. The device may identify an optimal edge device for the second PSA based on the latency data, and may generate a notification identifying the optimal edge device and the second PSA. The device may provide the notification to a user equipment affected by the failover from the first PSA to the second PSA.

### BACKGROUND

A user equipment (UE) may utilize a user plane function (UPF) in a fifth-generation (5G) network or a packet data network gateway (PGW) in a fourth-generation (4G) network as a protocol data unit (PDU) session anchor (PSA). The PSA may provide mobility for a UE within and between radio access technologies (RATs), including sending one or more end marker packets to a network element (e.g., a gNodeB or an eNodeB).

### BRIEF DESCRIPTION OF THE DRAWINGS

FIGS. 1A-1G are diagrams of an example embodiment associated with dynamic edge discovery after a PSA failover.

FIG. 2 is a diagram of an example environment in which systems and/or methods described herein may be implemented.

FIG. 3 is a diagram of example components of one or more devices of FIG. 2.

FIG. 4 is a flowchart of an example process for dynamic edge discovery after a PSA failover.

### DETAILED DESCRIPTION OF EXAMPLE EMBODIMENTS

The following detailed description of example implementations refers to the accompanying drawings. The same reference numbers in different drawings may identify the same or similar elements.

A PSA for a UE can be dynamically changed as a result of network events, such as PSA failover event due to a planned activity (e.g., software upgrades) or an unplanned activity (e.g., hardware or software failures). In such PSA failover events, the UE may be re-anchored from a primary PSA to secondary PSA. The primary PSA may be associated with a first site (e.g., a geographical location) and the secondary PSA may be associated with a second site (e.g., a geographical location). The first site may include a first multi-access edge computing (MEC) device that transmits traffic to and/or receives traffic from the UE anchored to the primary PSA. The second site may include a second MEC device. When the UE is re-anchored from the primary PSA to the secondary PSA, the UE may still utilize the first MEC device for the transmission and reception of the traffic. However, since the first MEC device is located at a different site than the secondary PSA, the UE may experience latency issues, quality of service (QoS) issues, and/or the like associated with the transmission and reception of the traffic.

Thus, current mechanisms for transmitting and receiving traffic after a PSA failover event consume computing resources (e.g., processing resources, memory resources, communication resources, and/or the like), networking resources, and/or other resources associated with identifying latency issues associated with the transmission and reception of the traffic between the UE and the MEC device, identifying QoS issues associated with the transmission and reception of the traffic between the UE and the MEC device, correcting the latency and QoS issues, and/or the like.

Some implementations described herein provide an edge discovery system that provides dynamic edge discovery after a PSA failover. For example, the edge discovery system may receive a PSA failure alarm associated with a first PSA at a first site with a first MEC device, and may receive a PSA active alarm associated with a second PSA at a second site. The edge discovery system may receive latency data identifying a latency between the first site and the second site, and may determine a failover from the first PSA to the second PSA based on the PSA failure alarm and the PSA active alarm. The edge discovery system may identify an optimal MEC device for the second PSA based on the latency data, and may generate a notification identifying the optimal MEC device and the second PSA. The edge discovery system may provide the notification to a UE affected by the failover from the first PSA to the second PSA, and the UE may establish a new session with the optimal MEC device based on the notification.

In this way, the edge discovery system provides dynamic edge discovery after a PSA failover. For example, a UE, anchored on a primary PSA, may be re-anchored to a secondary PSA as a result of a PSA failover event. The primary PSA and the secondary PSA may be located at sites associated with a transport latency between the sites. Hence an optimal MEC device, with respect to the UE's anchored PSA, may change. The edge discovery system may detect changes in a network (e.g., the PSA failover), and may recalculate an optimal MEC device (e.g., an optimal edge application server (EAS)). The edge discovery system may create a new session between the optimal MEC device and the UE. Alternatively, the edge discovery system may notify the UE about the optimal MEC device, and the UE may establish the new session with the optimal MEC device. Thus, the edge discovery system may conserve computing resources, networking resources, and/or other resources that would otherwise have been consumed in identifying a poor user experience associated with poor quality traffic, identifying an issue causing the poor quality traffic, correcting the issue causing the poor quality traffic, and/or the like.

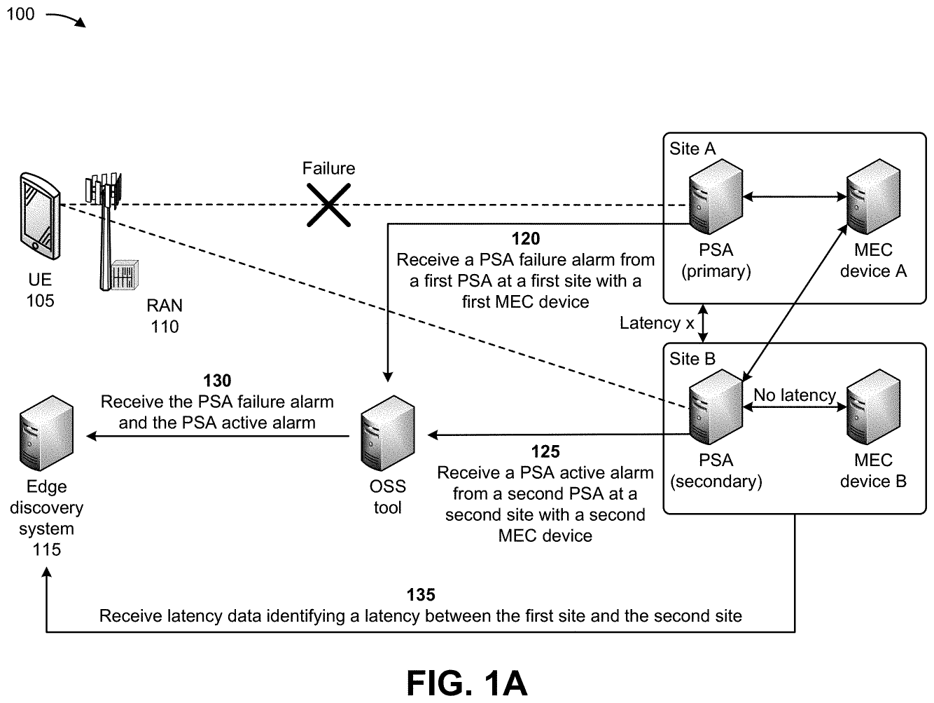

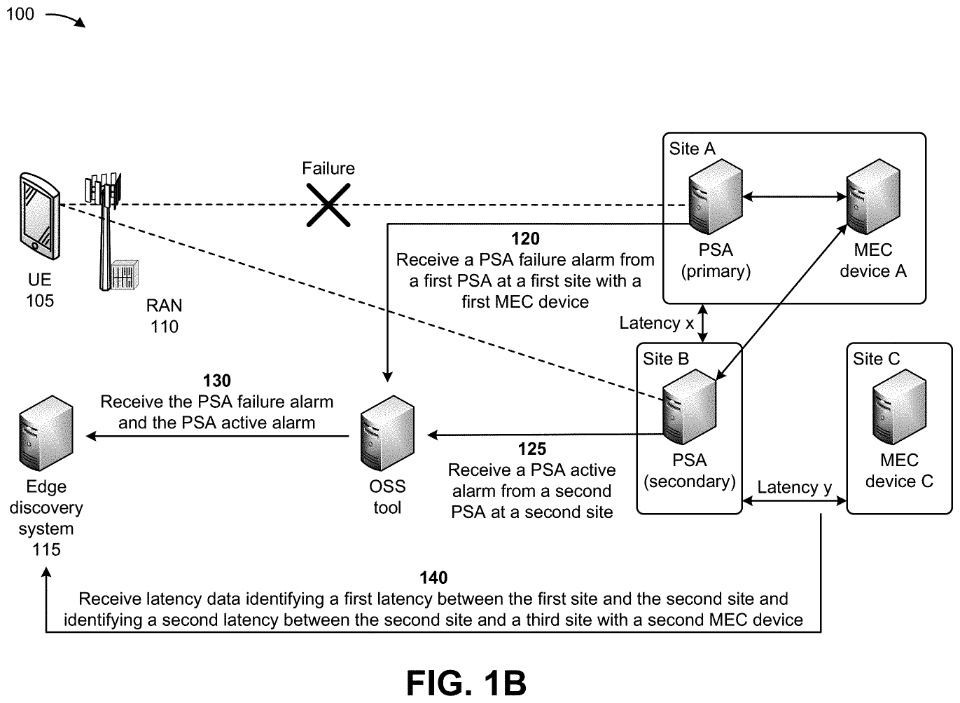

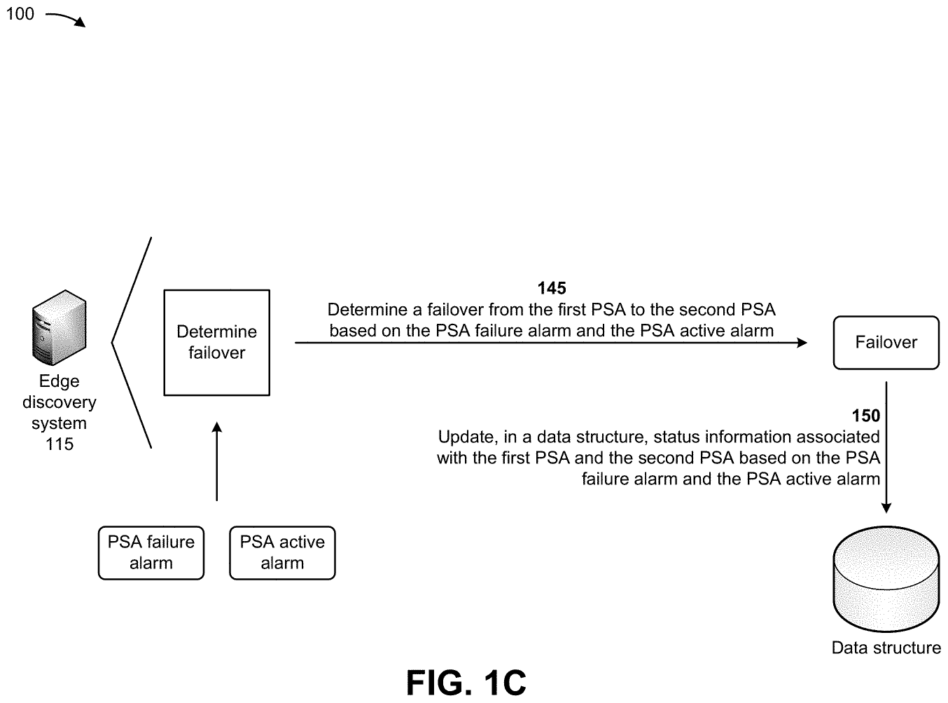

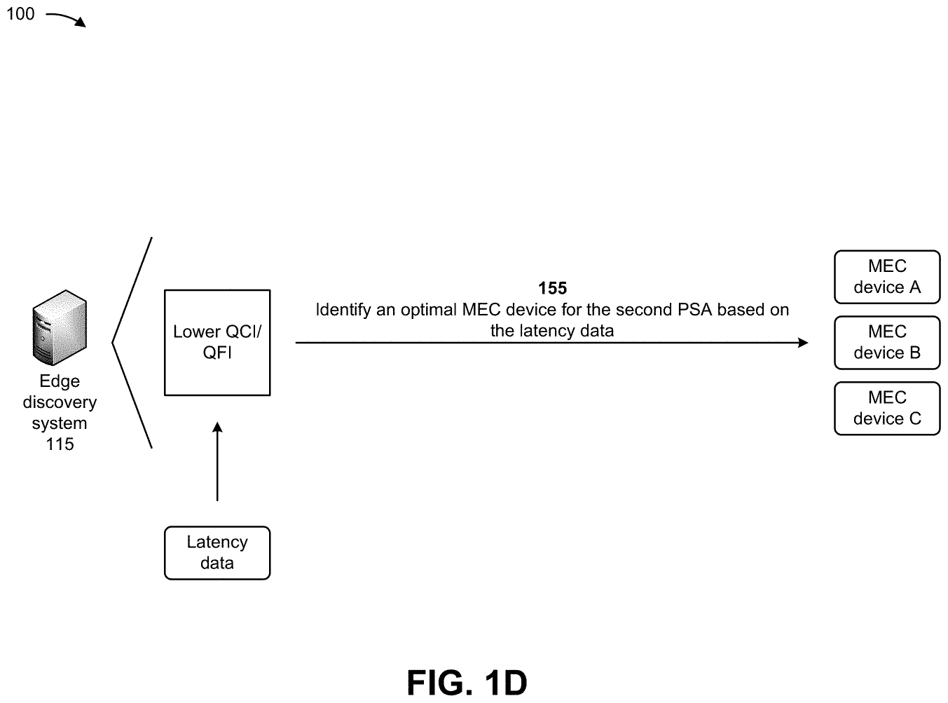

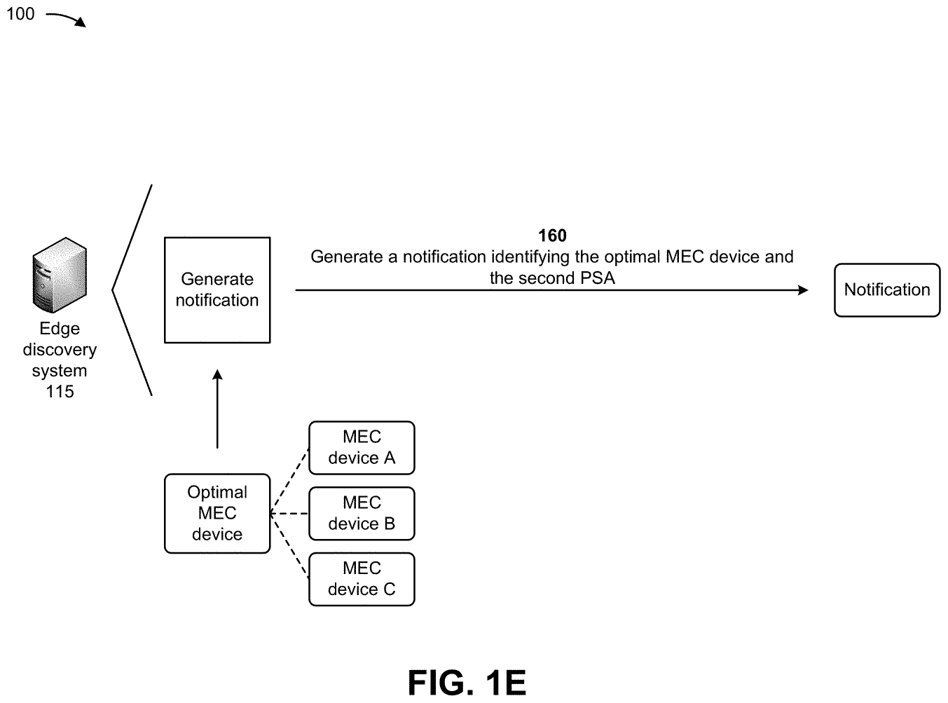

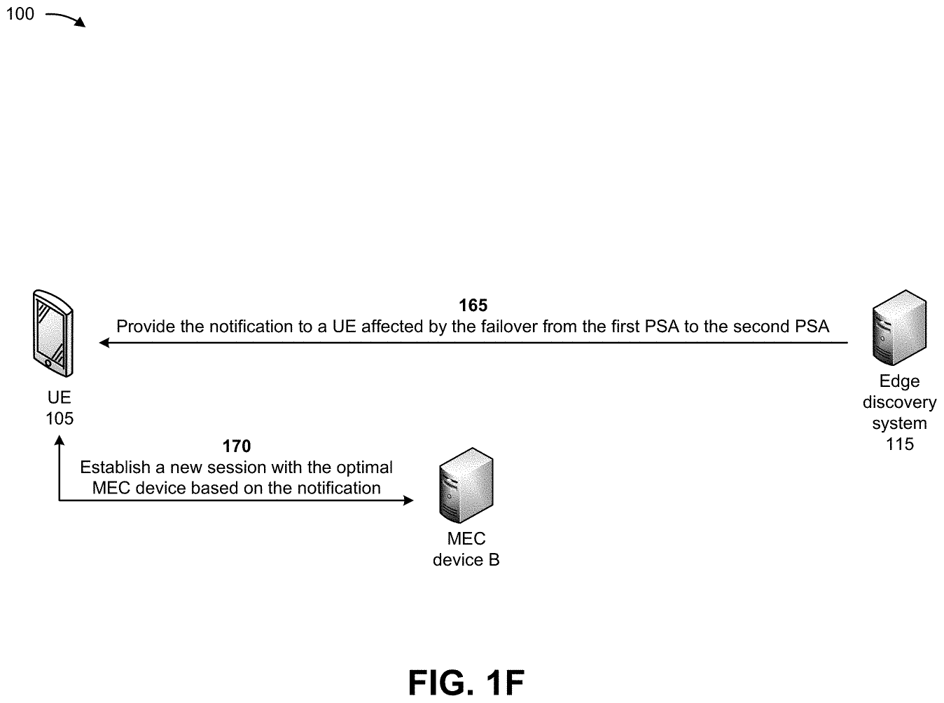

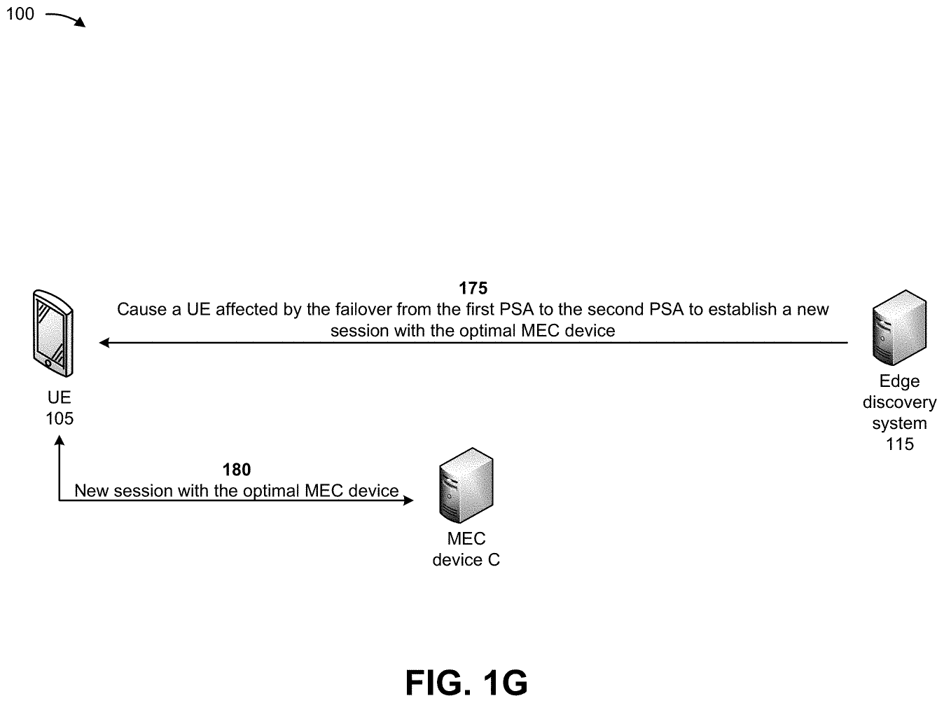

FIGS. 1A-1G are diagrams of an example 100 associated with dynamic edge discovery after a PSA failover. As shown in FIGS. 1A-1G, example 100 includes a UE 105, a RAN 110, an edge discovery system 115, an operation support subsystem (OSS) tool, MEC devices, and PSAs. Further details of the UE 105, the RAN 110, the edge discovery system 115, the OSS tool, the MEC devices, and the PSAs are provided elsewhere herein. Although only a single UE 105 and RAN 110 are depicted in FIG. 1A, in some implementations multiple UEs 105 and/or RANs 110 may be associated with the edge discovery system 115, the OSS tool, the MEC devices, and/or the PSAs.

As shown in FIG. 1A, a primary PSA associated with a first MEC device (e.g., MEC device A) may be provided in a first site (e.g., Site A), and a secondary PSA associated with a second MEC device (e.g., MEC device B) may be provided in a second site (e.g., Site B). Since the secondary PSA and the second MEC device are located at the same site (e.g., the second site), there may be no latency associated with communications between the secondary PSA and the second MEC device. Initially, the UE 105, via the RAN 110, may utilize the primary PSA as an anchor point. The primary PSA may provide mobility for the UE 105 within the RAN 110 and/or between RANs 110. However, a failure may occur between the UE and the primary PSA, as further shown in FIG. 1A. The failure (e.g., a failover event) may be caused by a planned activity (e.g., software upgrades), by an unplanned event (e.g., hardware or software failures), and/or the like. In such failover events, the PSA for the UE 105 may dynamically change and the UE 105 may be re-anchored from the primary PSA to the secondary PSA, as shown in FIG. 1A. The UE 105 may still be connected to the first MEC device even after the UE 105 is re-anchored to the secondary PSA. Thus, the UE 105 may experience additional latency (e.g., x seconds, milliseconds, and/or the like) associated with communications between the secondary PSA and the first MEC device, as a result of the failure.

As further shown in FIG. 1A, and by reference number 120, the OSS tool may receive a PSA failure alarm from a first PSA (e.g., the primary PSA) at the first site (e.g., Site A) with the first MEC device (e.g., MEC device A). For example, the first PSA may experience a failure event, such as a software upgrade, a software failure, a hardware failure, and/or the like, and may generate the PSA failure alarm based on the failure event. The first PSA may provide the PSA failure alarm to the OSS tool, and the OSS tool may receive the PSA failure alarm. Alternatively, or additionally, the OSS tool may provide heartbeat messages (e.g., to determine an operational status of the first PSA) to the first PSA, and the first PSA (e.g., when operational) may respond with heartbeat responses to the heartbeat messages. When not operational, the first PSA may not provide the heartbeat responses to the OSS tool, and the OSS tool may determine the PSA failure alarm based on the failure to receive the heartbeat responses from the first PSA.

As further shown in FIG. 1A, and by reference number 125, the OSS tool may receive a PSA active alarm from a second PSA (e.g., the secondary PSA) at a second site (e.g., Site B) with a second MEC device (e.g., MEC device B). For example, when the first PSA experiences the failure event, the second PSA may become active as the anchor point for the UE 105, via the RAN 110. When the second PSA becomes active, the second PSA may generate the PSA active alarm, and may provide the PSA active alarm to the OSS tool. The OSS tool may receive the PSA active alarm from the second PSA. Alternatively, or additionally, the OSS tool may provide heartbeat messages (e.g., to determine an operational status of the second PSA) to the second PSA. When operational, the second PSA may respond with heartbeat responses to the heartbeat messages, and the OSS tool may determine the PSA active alarm based on receiving the heartbeat responses from the second PSA.

As further shown in FIG. 1A, and by reference number 130, the edge discovery system 115 may receive the PSA failure alarm and the PSA active alarm. For example, the OSS tool may provide the PSA failure alarm and the PSA active alarm to the edge discovery system 115, and the edge discovery system 115 may receive the PSA failure alarm and the PSA active alarm from the OSS tool. In some implementations, the OSS tool may determine that a failover occurred from the first PSA to the second PSA based on the PSA failure alarm and the PSA active alarm. The OSS tool may generate a failover notification based on determining that the failover occurred from the first PSA to the second PSA, and may provide the failover notification to the edge discovery system 115. The edge discovery system 115 may receive the failover notification from the OSS tool. In some implementations, the edge discovery system 115 may receive the PSA failure alarm, the PSA active alarm, and/or the failover notification from the OSS tool via a messaging bus, a representational state transfer (REST) application programming interface (API), and/or the like. In some implementations, the edge discovery system 115 may include a microservice (e.g., an event consumer microservice) that subscribes to and listens to PSA failover events (e.g., on the messaging bus) from the OSS tool.

As further shown in FIG. 1A, and by reference number 135, the edge discovery system 115 may receive latency data identifying a latency between the first site and the second site. For example, a latency (e.g., x seconds, milliseconds, and/or the like) may be associated with communications between the first site and the second site, and the first PSA, the second PSA, the first MEC device, and/or the second MEC device may generate the latency data identifying the latency between the first site and the second site. The first PSA, the second PSA, the first MEC device, and/or the second MEC device may provide the latency data to the edge discovery system 115, and the edge discovery system 115 may receive the latency data from the first PSA, the second PSA, the first MEC device, and/or the second MEC device.

As shown in FIG. 1B, in some implementations, the second site (e.g., site B) may not include the second MEC device but may be connected to a third site (e.g., site C), and the third site (e.g., site C) may include the second MEC device (e.g., MEC device C). When the failover event occurs (e.g., as described above in connection with FIG. 1A), the PSA for the UE 105 may dynamically change and the UE 105 may be re-anchored from the primary PSA to the secondary PSA. The UE 105 may still be connected to the first MEC device even after the UE 105 is re-anchored to the secondary PSA. Thus, the UE 105 may experience a first latency (e.g., x seconds, milliseconds, and/or the like), associated with communications between the secondary PSA and the first MEC device, as a result of the failure and due to the first site and the second site being at different geographical locations. A second latency (e.g., y seconds, milliseconds, and/or the like) may be associated with communications between the second site and the third site since the second site and the third site are at different geographical locations.

As further shown in FIG. 1B, and by reference number 120, the OSS tool may receive the PSA failure alarm from the first PSA at the first site with the first MEC device, as described above in connection with FIG. 1A. As further shown in FIG. 1B, and by reference number 125, the OSS tool may receive the PSA active alarm from the second PSA at the second site with the second MEC device, as described above in connection with FIG. 1A. As further shown in FIG. 1B, and by reference number 130, the edge discovery system 115 may receive the PSA failure alarm and the PSA active alarm, as described above in connection with FIG. 1A.

As further shown in FIG. 1B, and by reference number 140, the edge discovery system 115 may receive latency data identifying a first latency between the first site (e.g., Site A) and the second site (e.g., Site B) and identifying a second latency between the second site and a third site (e.g., Site C) with a second MEC device (e.g., MEC device C). For example, the first latency (e.g., x seconds, milliseconds, and/or the like) may be associated with communications between the first site and the second site, and the first PSA, the second PSA, and/or the first MEC device may generate the latency data identifying the first latency between the first site and the second site. The first PSA, the second PSA, and/or the first MEC device may provide the latency data identifying the first latency to the edge discovery system 115, and the edge discovery system 115 may receive the latency data identifying the first latency from the first PSA, the second PSA, and/or the first MEC device. The second latency (e.g., y seconds, milliseconds, and/or the like) may be associated with communications between the second site and the third site, and the second PSA and/or the second MEC device may generate the latency data identifying the second latency between the second site and the third site. The second PSA and/or the second MEC device may provide the latency data identifying the second latency to the edge discovery system 115, and the edge discovery system 115 may receive the latency data identifying the second latency from the second PSA and/or the second MEC device.

As shown in FIG. 1C, and by reference number 145, the edge discovery system 115 may determine a failover from the first PSA to the second PSA based on the PSA failure alarm and the PSA active alarm. For example, the edge discovery system 115 may determine that the failover occurred from the first PSA to the second PSA based on the PSA failure alarm and the PSA active alarm. Alternatively, and/or additionally, the OSS tool may determine that the failover occurred from the first PSA to the second PSA based on the PSA failure alarm and the PSA active alarm. The OSS tool may generate a failover notification based on determining that the failover occurred from the first PSA to the second PSA, and may provide the failover notification to the edge discovery system 115. The edge discovery system 115 may receive the failover notification from the OSS tool, and may determine the failover from the first PSA to the second PSA based on the failover notification.

As further shown in FIG. 1C, and by reference number 150, the edge discovery system 115 may update, in a data structure (e.g., a database, a table, a list, and/or the like), status information associated with the first PSA and the second PSA based on the PSA failure alarm and the PSA active alarm. For example, the edge discovery system 115 may include a microservice (e.g., the event consumer microservice) that processes failover events and updates status information associated with the first PSA and the second PSA in the data structure. In case of a failover from the first PSA to the second PSA, the microservice may update a status of the first PSA to “inactive” (e.g., which indicates that traffic has failed over to the second PSA) in the data structure, and may update a status of the second PSA to “active” in the data structure.

As shown in FIG. 1D, and by reference number 155, the edge discovery system 115 may identify an optimal MEC device for the second PSA based on the latency data. For example, with respect to the scenario depicted in FIG. 1A, the edge discovery system 115 may determine that the latency (e.g., x seconds, milliseconds, and/or the like) between the second PSA and the first MEC device is greater than the latency (e.g., no latency) between the second PSA and the second MEC device. Thus, the edge discovery system 115 may determine that the second MEC device (e.g., MEC device B) is the optimal MEC device for the second PSA based on the latency data.

With respect to the scenario depicted in FIG. 1B, the edge discovery system 115 may determine that the latency (e.g., x seconds, milliseconds, and/or the like) between the second PSA and the first MEC device is greater than the latency (e.g., y seconds, milliseconds, and/or the like) between the second PSA and the second MEC device (e.g., MEC device C) located at the third site. Thus, the edge discovery system 115 may determine that the second MEC device (e.g., MEC device C) is the optimal MEC device for the second PSA based on the latency data. Alternatively, the edge discovery system 115 may determine that the latency (e.g., x seconds, milliseconds, and/or the like) between the second PSA and the first MEC device is less than the latency (e.g., y seconds, milliseconds, and/or the like) between the second PSA and the second MEC device (e.g., MEC device C) located at the third site. Thus, the edge discovery system 115 may determine that the first MEC device (e.g., MEC device A) is the optimal MEC device for the second PSA based on the latency data.

In some implementations, the edge discovery system 115 may include a microservice (e.g., an event handler microservice) that calculates an optimal MEC device and service endpoints for all of the subnets that were previously anchored on the first PSA (e.g., the failing PSA). The microservice may also generate notifications (e.g., for the UE 105 and the subnets) identifying the optimal MEC device and/or the service endpoints.

As shown in FIG. 1E, and by reference number 160, the edge discovery system 115 may generate a notification identifying the optimal MEC device and the second PSA. For example, the edge discovery system 115 may generate a notification message that identifies the optimal MEC device (e.g., one of MEC device A, MEC device B, or MEC device C) and the failover PSA (e.g., the second PSA). In some implementations, the notification may also identify one or more service endpoints in addition to identifying the optimal MEC device and the second PSA.

As shown in FIG. 1F, and by reference number 165, the edge discovery system 115 may provide the notification to a UE (e.g., the UE 105) affected by the failover from the first PSA to the second PSA. For example, the edge discovery system 115 may include a microservice (e.g., a notification microservice) that identifies users (e.g., users of the UE 105 and/or other UEs) affected by the failover from the first PSA to the second PSA and subscribed to receiving notifications about failovers. The edge discovery system 115 may utilize the microservice to provide the notification to the UE 105 and/or the other UEs affected by the failover from the first PSA to the second PSA and subscribed to receiving notifications about failovers.

As further shown in FIG. 1F, and by reference number 170, the UE 105 may establish a new session with the optimal MEC device (e.g., MEC device B) based on the notification. For example, the UE 105 may receive the notification identifying the optimal MEC device (e.g., MEC device B), and may establish the new session with the optimal MEC device based on the notification. The UE 105 may terminate a session with the first MEC device (e.g., MEC device A) based on the notification, and may establish the new session with the optimal MEC device after terminating the session with the first MEC device. In some implementations, the UE 105 may not establish the new session with the optimal MEC device and may continue to utilize the session with the first MEC device, for example (but may experience latency issues). In some implementations, the edge discovery system 115 may automatically terminate the session between the UE 105 and the first MEC device, and may automatically establish the new session between the UE 105 and the optimal MEC device.

As shown in FIG. 1G, and by reference number 175, the edge discovery system 115 may cause a UE (e.g., the UE 105) affected by the failover from the first PSA to the second PSA to establish a new session with the optimal MEC device (e.g., MEC device C). For example, the edge discovery system 115 may automatically terminate a session between the UE 105 and the first MEC device (e.g., MEC device A), and may automatically establish the new session between the UE 105 and the optimal MEC device (e.g., MEC device C). The edge discovery system 115 may also cause other UEs affected by the failover from the first PSA to the second PSA to establish new sessions with the optimal MEC device (e.g., MEC device C). In some implementations, the UE 105 may receive the notification identifying the optimal MEC device (e.g., MEC device C), and may establish the new session with the optimal MEC device based on the notification.

As further shown in FIG. 1G, and by reference number 180, the new session may be established between the UE 105 and the optimal MEC device (e.g., MEC device C). For example, the UE 105 may establish the new session with the optimal MEC device, via the second PSA, and may exchange communications with the optimal MEC device via the new session.

In this way, the edge discovery system 115 provides dynamic edge discovery after a PSA failover. For example, a UE 105, anchored on a primary PSA, may be re-anchored to a secondary PSA as a result of PSA failover event. The primary PSA and the secondary PSA may be located at sites associated with a transport latency between the sites. Hence an optimal MEC device, with respect to the anchored PSA of the UE 105, may change. The edge discovery system 115 may detect changes in a network (e.g., the PSA failover), and may recalculate an optimal MEC device (e.g., an optimal EAS). The edge discovery system 115 may create a new session between the optimal MEC device and the UE 105. Alternatively, the edge discovery system may notify the UE 105 about the optimal MEC device, and the UE 105 may establish the new session with the optimal MEC device. Thus, the edge discovery system 115 may conserve computing resources, networking resources, and/or other resources that would otherwise have been consumed in identifying a poor user experience associated with poor quality traffic, identifying an issue causing the poor quality traffic, correcting the issue causing the poor quality traffic, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

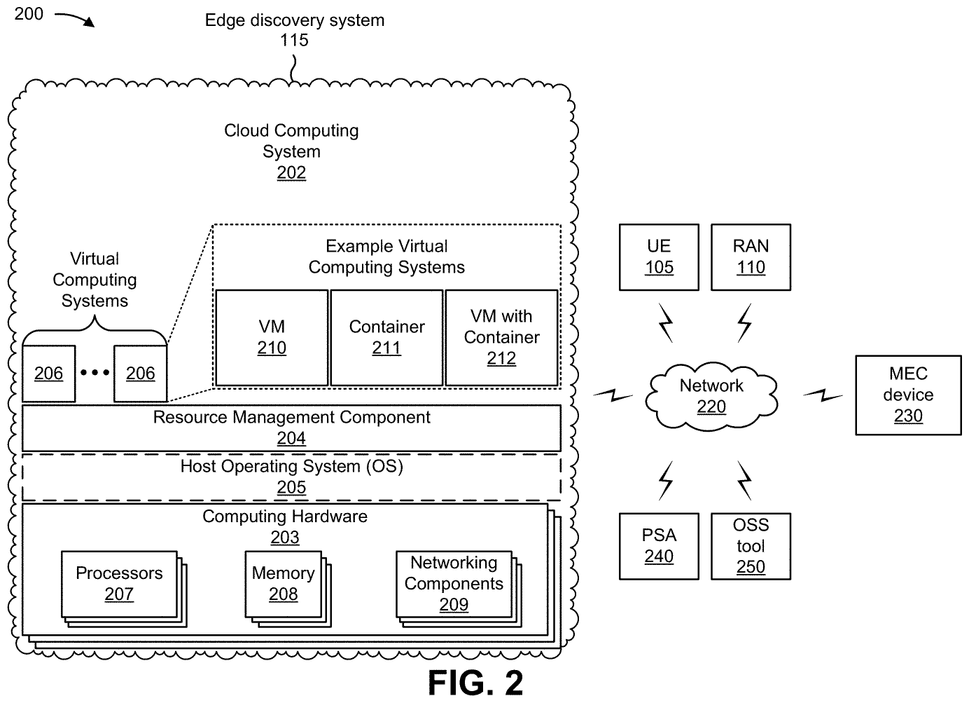

FIG. 2 is a diagram of an example environment 200 in which systems and/or methods described herein may be implemented. As shown in FIG. 2, the environment 200 may include the edge discovery system 115, which may include one or more elements of and/or may execute within a cloud computing system 202. The cloud computing system 202 may include one or more elements 203-212, as described in more detail below. As further shown in FIG. 2, the environment 200 may include the UE 105, the RAN 110, a network 220, an MEC device 230, a PSA 240, and/or an OSS tool 250. Devices and/or elements of the environment 200 may interconnect via wired connections and/or wireless connections.

The UE 105 includes one or more devices capable of receiving, generating, storing, processing, and/or providing information, such as information described herein. For example, the UE 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 110 may support, for example, a cellular radio access technology (RAT). The RAN 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The RAN 110 may transfer traffic between the UE 105 (e.g., using a cellular RAT), one or more base stations (e.g., using a wireless interface or a backhaul interface, such as a wired backhaul interface), and/or a core network. The RAN 110 may provide one or more cells that cover geographic areas.

In some implementations, the RAN 110 may perform scheduling and/or resource management for the UE 105 covered by the RAN 110 (e.g., the UE 105 covered by a cell provided by the RAN 110). In some implementations, the RAN 110 may be controlled or coordinated by a network controller, which may perform load balancing, network-level configuration, and/or other operations. The network controller may communicate with the RAN 110 via a wireless or wireline backhaul. In some implementations, the RAN 110 may include a network controller, a self-organizing network (SON) module or component, or a similar module or component. In other words, the RAN 110 may perform network control, scheduling, and/or network management functions (e.g., for uplink, downlink, and/or sidelink communications of the UE 105 covered by the RAN 110).

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, and/or one or more networking components 209. Examples of a processor, a memory, and a networking component (e.g., a communication component) are described elsewhere herein.

The resource management component 204 includes a virtualization application (e.g., executing on hardware, such as the computing hardware 203) capable of virtualizing the computing hardware 203 to start, stop, and/or manage the one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 includes a virtual environment that enables cloud-based execution of operations and/or processes described herein using the computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

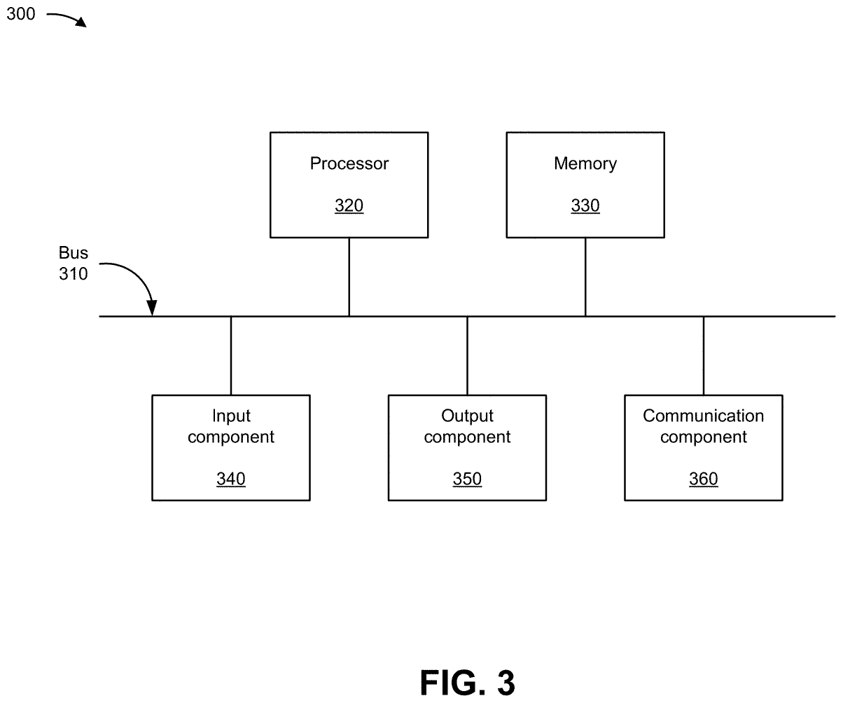

Although the edge discovery system 115 may include one or more elements 203-212 of the cloud computing system 202, may execute within the cloud computing system 202, and/or may be hosted within the cloud computing system 202, in some implementations, the edge discovery system 115 may not be cloud-based (e.g., may be implemented outside of a cloud computing system) or may be partially cloud-based. For example, the edge discovery system 115 may include one or more devices that are not part of the cloud computing system 202, such as a device 300 of FIG. 3, which may include a standalone server or another type of computing device. The edge discovery system 115 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of environment 200.

The MEC device 230 includes one or more devices capable of receiving, generating, storing, processing, providing, and/or routing information, as described elsewhere herein. The MEC device 230 may include a communication device and/or a computing device. For example, the MEC device 230 may include a server, such as an application server, a client server, a web server, a database server, a host server, a proxy server, a virtual server (e.g., executing on computing hardware), or a server in a cloud computing system. In some implementations, the MEC device 230 includes computing hardware used in a cloud computing environment. The MEC device 230 may provide services and computing functions, required by UEs 105, on edge nodes. The MEC device 230 may provide application services and content closer to UEs 105 and may implement network collaboration.

The PSA 240 includes one or more devices capable of providing connectivity for the UE 105 to external packet data networks. For example, the PSA 240 may include one or more data processing and/or traffic transfer devices, such as a gateway, a router, a modem, a switch, a firewall, a network interface card (MC), a hub, a bridge, a server device, an optical add-drop multiplexer (OADM), or any other type of device that processes and/or transfers traffic. In some implementations, the PSA 240 may aggregate traffic, and may send the aggregated traffic to the network 220. Additionally, or alternatively, the PSA 240 may receive traffic from the network 220, and may send the traffic to the UE 105 and the RAN 110. In some implementations, the PSA 240 may serve as an anchor point for intraRAT and/or interRAT mobility. The PSA 240 may apply rules to packets, such as rules pertaining to packet routing, traffic reporting, and/or handling user plane QoS, among other examples.

The OSS tool 250 includes one or more devices capable of receiving, generating, storing, processing, providing, and/or routing information, as described elsewhere herein. The OSS tool 250 may include a communication device and/or a computing device. For example, the OSS tool 250 may include a server, such as an application server, a client server, a web server, a database server, a host server, a proxy server, a virtual server (e.g., executing on computing hardware), or a server in a cloud computing system. In some implementations, the OSS tool 250 includes computing hardware used in a cloud computing environment.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the UE 105, the RAN 110, the edge discovery system 115, the MEC device 230, the PSA 240, and/or the OSS tool 250. In some implementations, the UE 105, the RAN 110, the edge discovery system 115, the MEC device 230, the PSA 240, and/or the OSS tool 250 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. Memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

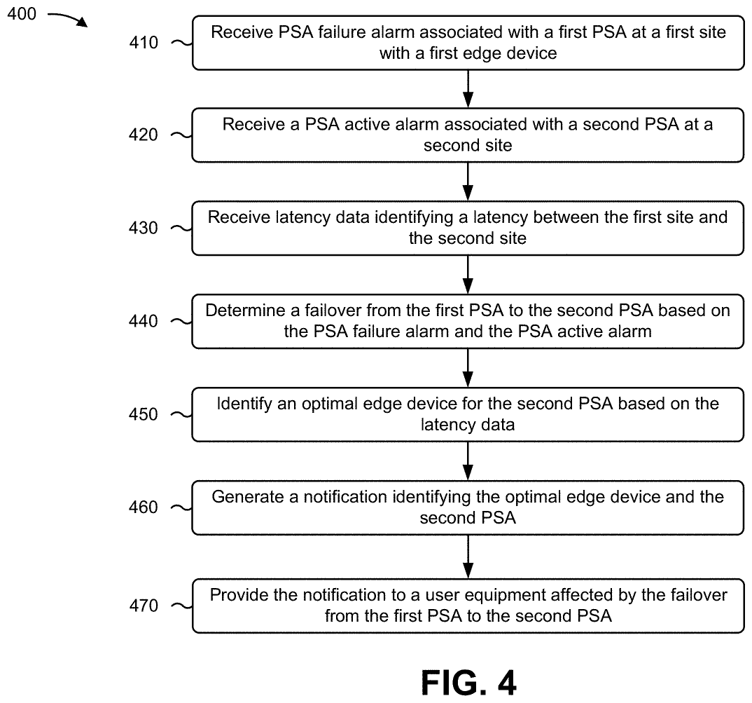

FIG. 4 is a flowchart of an example process 400 for dynamic edge discovery after a PSA failover. In some implementations, one or more process blocks of FIG. 4 may be performed by a device (e.g., the edge discovery system 115). In some implementations, one or more process blocks of FIG. 4 may be performed by another device or a group of devices separate from or including the device, such as an MEC device (e.g., the MEC device 230) a PSA (e.g., the PSA 240), and/or an OSS tool (e.g., the OSS tool 250). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving a PSA failure alarm associated with a first PSA at a first site with a first edge device (block 410). For example, the device may receive a PSA failure alarm associated with a first PSA at a first site with a first edge device, as described above.

As further shown in FIG. 4, process 400 may include receiving a PSA active alarm associated with a second PSA at a second site (block 420). For example, the device may receive a PSA active alarm associated with a second PSA at a second site, as described above. In some implementations, each of the first PSA and the second PSA is a user plane function or a packet data network gateway. In some implementations, the PSA failure alarm and the PSA active alarm are received from an operation support subsystem tool.

As further shown in FIG. 4, process 400 may include receiving latency data identifying a latency between the first site and the second site (block 430). For example, the device may receive latency data identifying a latency between the first site and the second site, as described above.

As further shown in FIG. 4, process 400 may include determining a failover from the first PSA to the second PSA based on the PSA failure alarm and the PSA active alarm (block 440). For example, the device may determine a failover from the first PSA to the second PSA based on the PSA failure alarm and the PSA active alarm, as described above.

As further shown in FIG. 4, process 400 may include identifying an optimal edge device for the second PSA based on the latency data (block 450). For example, the device may identify an optimal edge device for the second PSA based on the latency data, as described above. In some implementations, the second site includes a second edge device, and identifying the optimal edge device for the second PSA based on the latency data includes identifying the second edge device as the optimal edge device for the second PSA based on the latency data. In some implementations, each of the first edge device and the second edge device is a multi-access edge computing device. In some implementations, each of the first edge device and the second edge device includes an edge application server.

In some implementations, a third site includes a second edge device, the latency data identifies another latency between the second site and a third site, and identifying the optimal edge device for the second PSA based on the latency data includes identifying the second edge device as the optimal edge device for the second PSA based on the latency data indicating that the other latency is less than the latency. In some implementations, identifying the optimal edge device for the second PSA based on the latency data includes identifying the first edge device as the optimal edge device for the second PSA based on the latency data indicating that the latency is less than the other latency.

As further shown in FIG. 4, process 400 may include generating a notification identifying the optimal edge device and the second PSA (block 460). For example, the device may generate a notification identifying the optimal edge device and the second PSA, as described above.

As further shown in FIG. 4, process 400 may include providing the notification to a user equipment affected by the failover from the first PSA to the second PSA (block 470). For example, the device may provide the notification to a user equipment affected by the failover from the first PSA to the second PSA, as described above. In some implementations, the user equipment is configured to establish a new session with the optimal edge device based on the notification. In some implementations, the user equipment is subscribed to receiving the notification identifying the optimal edge device and the second PSA.

In some implementations, process 400 includes updating, in a data structure, status information associated with the first PSA and the second PSA based on the PSA failure alarm and the PSA active alarm. In some implementations, process 400 includes causing the user equipment affected by the failover from the first PSA to the second PSA to establish the new session with the optimal edge device.

In some implementations, process 400 includes identifying a plurality of user equipment as being affected by the failover from the first PSA to the second PSA, and providing the notification to the plurality of user equipment based on identifying the plurality of user equipment, wherein each of the plurality of user equipment is configured to establish a new session with the optimal edge device based on the notification. In some implementations, process 400 includes listening for PSA failover events generated by an operation support subsystem tool, and receiving the PSA failure alarm and the PSA active alarm from the operation support subsystem tool based on listening for the PSA failover events.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a protocol data unit session anchor (PSA) failure alarm associated with a first PSA at a first site with a first edge device;
receiving, by the device, a PSA active alarm associated with a second PSA at a second site;
receiving, by the device, latency data identifying a latency between the first site and the second site;
determining, by the device, a failover from the first PSA to the second PSA based on the PSA failure alarm and the PSA active alarm;
identifying, by the device, an optimal edge device for the second PSA based on the latency data;
generating, by the device, a notification identifying the optimal edge device and the second PSA; and
providing, by the device, the notification to a user equipment affected by the failover from the first PSA to the second PSA,
wherein the user equipment is configured to establish a new session with the optimal edge device based on the notification.

2. The method of claim 1, wherein the second site includes a second edge device and identifying the optimal edge device for the second PSA based on the latency data comprises:
identifying the second edge device as the optimal edge device for the second PSA based on the latency data.

3. The method of claim 2, wherein each of the first edge device and the second edge device is a multi-access edge computing device.

4. The method of claim 2, wherein each of the first edge device and the second edge device includes an edge application server.

5. The method of claim 1, wherein a third site includes a second edge device, the latency data identifies another latency between the second site and a third site, and identifying the optimal edge device for the second PSA based on the latency data comprises:
identifying the second edge device as the optimal edge device for the second PSA based on the latency data indicating that the other latency is less than the latency.

6. The method of claim 5, wherein identifying the optimal edge device for the second PSA based on the latency data comprises:
identifying the first edge device as the optimal edge device for the second PSA based on the latency data indicating that the latency is less than the other latency.

7. The method of claim 1, further comprising:
updating, in a data structure, status information associated with the first PSA and the second PSA based on the PSA failure alarm and the PSA active alarm.

8. A device, comprising:
one or more processors configured to:
receive a protocol data unit session anchor (PSA) failure alarm associated with a first PSA at a first site with a first edge device;
receive a PSA active alarm associated with a second PSA at a second site;
update, in a data structure, status information associated with the first PSA and the second PSA based on the PSA failure alarm and the PSA active alarm;
receive latency data identifying a latency between the first site and the second site;
determine a failover from the first PSA to the second PSA based on the PSA failure alarm and the PSA active alarm;
identify an optimal edge device for the second PSA based on the latency data;
generate a notification identifying the optimal edge device and the second PSA; and
provide the notification to a user equipment affected by the failover from the first PSA to the second PSA,
wherein the user equipment is configured to establish a new session with the optimal edge device based on the notification.

9. The device of claim 8, wherein the one or more processors are further configured to:
cause the user equipment affected by the failover from the first PSA to the second PSA to establish the new session with the optimal edge device.

10. The device of claim 8, wherein each of the first PSA and the second PSA is a user plane function or a packet data network gateway.

11. The device of claim 8, wherein the PSA failure alarm and the PSA active alarm are received from an operation support subsystem tool.

12. The device of claim 8, wherein the one or more processors are further configured to:
identify a plurality of user equipment as being affected by the failover from the first PSA to the second PSA; and
provide the notification to the plurality of user equipment based on identifying the plurality of user equipment,
wherein each of the plurality of user equipment is configured to establish a new session with the optimal edge device based on the notification.

13. The device of claim 8, wherein the one or more processors are further configured to:
listen for PSA failover events generated by an operation support subsystem tool; and
receive the PSA failure alarm and the PSA active alarm from the operation support subsystem tool based on listening for the PSA failover events.

14. The device of claim 8, wherein the user equipment is subscribed to receiving the notification identifying the optimal edge device and the second PSA.

15. A non-transitory computer-readable medium storing a set of instructions, the set of instructions comprising:
one or more instructions that, when executed by one or more processors of a device, cause the device to:
receive a protocol data unit session anchor (PSA) failure alarm associated with a first PSA at a first site with a first edge device;
receive a PSA active alarm associated with a second PSA at a second site;
receive latency data identifying a latency between the first site and the second site;
determine a failover from the first PSA to the second PSA based on the PSA failure alarm and the PSA active alarm;
identify an optimal edge device for the second PSA based on the latency data;
generate a notification identifying the optimal edge device and the second PSA; and
provide the notification to one or more user equipments affected by the failover from the first PSA to the second PSA,
wherein the one or more user equipments are configured to establish new sessions with the optimal edge device based on the notification.

16. The non-transitory computer-readable medium of claim 15, wherein the second site includes a second edge device and the one or more instructions, that cause the device to identify the optimal edge device for the second PSA based on the latency data, cause the device to:
identify the second edge device as the optimal edge device for the second PSA based on the latency data.

17. The non-transitory computer-readable medium of claim 15, wherein a third site includes a second edge device, the latency data identifies another latency between the second site and a third site, and the one or more instructions, that cause the device to identify the optimal edge device for the second PSA based on the latency data, cause the device to:
identify the second edge device as the optimal edge device for the second PSA based on the latency data indicating that the other latency is less than the latency.

18. The non-transitory computer-readable medium of claim 17, wherein the one or more instructions, that cause the device to identify the optimal edge device for the second PSA based on the latency data, cause the device to:
identify the first edge device as the optimal edge device for the second PSA based on the latency data indicating that the latency is less than the other latency.

19. The non-transitory computer-readable medium of claim 15, wherein the one or more instructions further cause the device to:
cause the user equipment affected by the failover from the first PSA to the second PSA to establish a new session with the optimal edge device.

20. The non-transitory computer-readable medium of claim 15, wherein each of the first PSA and the second PSA is a user plane function or a packet data network gateway.
